(19) United States
(12) Patent Application Publication
(10) Pub. No.: US 2021/0246939 A1
(43) Pub. Date: Aug. 12, 2021

(54) SECURING ELEMENT FOR AXIALLY SECURING A SHAFT

(71) Applicant: B. Braun Melsungen AG, Melsungen (DE)

(72) Inventors: Hans-Josef Gerlach, Marsberg (DE); Jens Schäfer, Stuttgart (DE); Joachim Schütz, Fulda (DE)

(21) Appl. No.: 17/271,230

(22) PCT Filed: Sep. 4, 2019
(86) PCT No.: PCT/EP2019/073578

§ 371 Date: Feb. 25, 2021

(30) Foreign Application Priority Data
Sep. 4, 2018 (DE) 10 2018 121 487.1

(51) Int. Cl. F16C 17/04; F16C 33/04

(52) U.S. Cl. CPC F16C 17/04; F16B 21/16; F16C 33/046

(57) ABSTRACT

A securing element for axially securing a shaft or a component on a shaft includes at least two sector elements that can be joined to each other to form an essentially closed ring form with a central through opening for the shaft. The sector elements have latching structures or snap-fit structures, by which they can be connected to each other. The latching structures include a groove-like indentation with a first snap-fit hook formed in a first one of the sector elements and a spring arm with a second snap-fit hook arranged on a second one of the sector elements and engaging in the indentation in the first sector element.

### CROSS-REFERENCE TO RELATED APPLICATION(S)

This application is the United States national phase entry of International Application No. PCT/EP2019/073578, filed Sep. 4, 2019, and claims the benefit of priority of German Application No. 10 2018 121 487.1, filed Sep. 4, 2018. The contents of International Application No. PCT/EP2019/073578 and German Application No. 10 2018 121 487.1 are incorporated by reference herein in their entireties.

### FIELD

The present invention relates to a securing element for axially securing a component with a shaft, with at least two sector elements which can be joined together to form a closed ring form with a central through opening for the shaft, wherein the sector elements each have latching structures by means of which they can be connected to each other, in particular can be connected in a loss-proof manner.

### BACKGROUND

When components are arranged on a shaft or a shaft is arranged in or on a component, securing elements of the type mentioned at the beginning are used in order to achieve an axially fixed positioning of shaft and component in relation to each other. In particular, the securing element has to be able to absorb axial forces acting between shaft and component and to transmit these forces between them.

The prior art shows securing elements known in particular as Seeger rings, which are standardized in DIN 471. In addition, shaft securing rings are known according to DIN 6799. These known securing rings do not consist of a complete ring, but only of a partial ring segment with two opposite segment ends, between which there is a clearance or a gap. This clearance or gap serves to mount the securing elements by mounting the partial ring segment on a shaft or in a bore, ideally under purely elastic deformation. Due to their elastic, intentional deformability, such securing rings tend to undergo repeated, unintentional deformation under extreme loads, in particular axial loads (e.g. in the event of a dropped device), or even to jump off the shaft/out of the bore, since the securing rings can simply widen/narrow and are therefore not always securely held in a groove of the shaft/the bore. It is therefore a disadvantage that it is often possible that such securing rings fail before their material has actually been deformed beyond the shear limit. A further disadvantage is that these known securing rings must also be opened/closed during assembly and are thus widened/narrowed. Particularly with securing rings according to DIN 471, there is a risk of plastic deformation of the material during assembly, which in some cases can significantly reduce the axial load capacity of the securing ring.

From DE 10 2012 013991 A1, an axial bearing assembly with a shaft, a component supported on the shaft, and a disk assembly accommodated in a groove of the shaft is known. The disk assembly is arranged adjacent to the component so that axial forces from the component can be conducted into the shaft via the disk assembly. While the disk assembly has an axial disk thickness, the groove has an axial groove width that is larger than the disk thickness. A ring part is therefore inserted into the groove as compensation, so that axial forces can be conducted from the component via the disk assembly and via the ring part into the shaft. A disadvantage of this disk assembly is that the two ring segments of the disk assembly have to be joined together in the axial direction, so that the further ring part is required for axially determined positioning.

From DE 10 2012 013992 A1, a securing disk is known for shafts with a first and a second sector element that can be connected to form a circular form. The sector elements each have a ring-sector shaped base body with two ends, wherein one end of each base body has a detent and the other end of each base body has a latching groove. The sector elements are connectable to each other to form a securing disk in such a way that the detent of the first sector element latches into the latching groove of the second sector element, wherein the latching mechanism is designed in such a way that the sector elements are coupled to each other in a loss-proof manner. A disadvantage of this securing disk is that the two base bodies are to be joined together with deformation of their outer circumference at least in the area of the detent, so that the relative position of the base bodies to each other can become indeterminate if they are used several times as a result of wear.

From AT 236 709 B, a device is known for securing a machine part on a shaft against axial displacement in the form of a split securing ring. This ring has two self-resilient ring segments of the same shape, the free ends of which are designed as hooks in the ring plane. When assembling the ring segments, the hooks slide over each other in a groove of the shaft in a resilient manner until they snap into the hook indentations of the counter segment and hold the segments together in the form of a complete ring. For an essentially rigid design of the segment body, each of the two ring segments is tapered on one side to form a resilient cantilever which ends in a nose-shaped projection and the inner edge of which is offset from that of the rigid segment body to receive a locking part of the other ring segment. On the other hand, the other side of the ring segment has a tongue whose outer edge is offset from the outer edge of the segment body. Between the outer edge of the tongue and the outer edge of the segment body, a recess is formed to receive the nose-shaped projection of the other ring segment. A disadvantage of this securing ring is that the two segments have to be joined together by expanding the entire segments under deformation at least in the area of the cantilevers, so that the relative position of the segments to each other can become indeterminate if they are used several times due to wear.

### SUMMARY

Based on the problem explained above, the invention is based on the object of eliminating the previously mentioned disadvantages. In particular, a solution is to be found which provides a robust axial securing on a shaft with groove.

In particular, the invention provides a securing element (shaft ring) for axially securing a component with a shaft, and/or a shaft in a component such as a housing, and/or a component on a shaft, with two sector elements in the form of semicircular disks (half-ring disks), each having a semicircular outer edge and an inner, straight disk edge forming a substantially semicircular notch, and which can be joined together to form a closed ring form with a central through opening for the shaft, wherein the sector elements each have latching structures (groove and spring profiles), which can in particular be designed as snap-fit structures, by means of which they can be connected to each other, in particular can be connected in a loss-proof manner, wherein the latching structures comprise at least one groove-shaped indentation which is introduced into a first one of the sector elements with a first snap-fit hook/undercut and at least one spring arm which is arranged on a second one of the sector elements and engages in the groove in the first sector element and has a second snap-fit hook/protrusion. In this case, the (all) latching structures of each semicircular disk are each arranged (completely) at a (radial) distance/offset from its semicircular outer edge as well as from its semicircular notch at its inner, straight disk edge.

It can also be said that the latching structures of each semicircular disk are each (completely) arranged between its semicircular outer edge and its semicircular notch at its inner, straight disk edge, more precisely between the respective ends of the semicircular outer edge meeting the inner disk edge and those of the semicircular notch.

Particularly preferably, the (all) latching structures of the semicircular disks are each arranged (substantially) centrally between (the ends of) the semicircular outer edge and (the ends of) the semicircular notch at the straight disk edges.

More specifically, the semicircular notches each divide the inner, straight disk edges of the semicircular disks (in the center of the straight disk edge) into two straight edge sections, and a respective latching structure is arranged centrally on each straight edge section, i.e. between (one end of) the semicircular outer edge and (one end of) the semicircular notch.

Alternatively, it is preferred that a respective latching structure is (completely) arranged in the respective radially outer half of the straight edge sections formed in this way.

In this way, it is possible for the semicircular disks to be joined radially (in the radial direction of the semicircular disks or of the securing element) without the semicircular disks (elastically) expanding/widening beyond their radius defined by the semicircular outer edge and without the semicircular disks (elastically) expanding/widening into the semicircular notch when joining or during joining.

In other words, the securing element or shaft ring according to the invention consists of two semicircular disks, each with an inner, straight disk edge and an outer, semicircular disk edge. The inner, straight disk edge forms an essentially semicircular notch, so that when the two semicircular disks are connected, a central, essentially circular through hole is formed at their respective inner, straight disk edges. On both sides of each semicircular notch, latching structures, preferably snap-fit structures, are formed on the inner, straight disk edge (one piece of material), in particular in the form of a slit or groove with an undercut acting in the insertion/removal direction and/or a stud/pin or spring (arm) with a projection acting in the insertion/removal direction, which comes into latching engagement with the undercut when the stud of one semicircular disk is inserted into the slit of the other semicircular disk for the purpose of mounting the latter.

The semicircular disk may be formed only with grooves or studs or the semicircular disk may have one groove and one stud each.

The invention enables in an advantageous way a securing element which provides a particularly simple and safe axial locking effect between a shaft and another component to be arranged axially fixed to it, for example a bearing to be arranged on the shaft. The securing element is suitable for forming an axially rigid assembly for both components that are rotationally fixed to the shaft and components that are rotatable to the shaft. The sector elements can simply be arranged individually on the shaft from different directions, in particular opposite radial directions, and are automatically connected with each other by their latching structures to form an essentially ring-shaped, closed securing element when they are arranged on the shaft and joined to each other in the intended manner. A particular advantage is that the sector elements can simply be arranged at the shaft in the orthogonal direction and joined together. This makes the securing element according to the invention particularly suitable for use in confined spaces and limited accessibility, such as in a groove of the shaft.

The invention achieves in particular the advantage that the latching connection between the individual sector elements is particularly stable due to the formation of their latching structures as groove-shaped indentation on the one hand and the spring arm engaging in them on the other hand, and in particular can even be undetachable. The resulting locking geometry ensures that the sector elements remain closed even if high axial and/or radial forces occur. Since a relative movement of the spring arm to the groove-shaped indentation receiving it is necessary in order to release the snap-fit connection between the latching structures, i.e. a separation of the sector elements from each other is not possible in particular by a relative movement of the entire sector elements to each other, the coupling of the sector elements to each other and thus the securing element is particularly safe and reliable. According to the invention, the latching structures of the groove-shaped indentation and the spring arm are in particular designed in such a way that they interlock with each other in a form-fitting manner. In addition, all sector elements can be connected to each other in a form-fitting manner.

Advantageous embodiments of the invention are explained in more detail below.

One embodiment of the securing element is characterized in that the sector elements are essentially shaped like partial rings. In particular, the sector elements complement each other to form a complete ring when joined together as intended. This embodiment ensures that the securing element can form a particularly large seating or contact area with the shaft (and also with the component to be joined with the shaft) that surrounds the shaft in particular completely, and that relatively large forces can also be transmitted in a way that is material and component friendly.

In a further embodiment, the sector elements are divided along a dividing plane in which, if the sector elements are arranged as intended, their longitudinal axis lies at a shaft. By such a division, the sector elements can easily be arranged at/on the shaft and in particular in a groove integrated in it.

According to another embodiment, the groove-shaped indentation and the spring arm extend orthogonally to the dividing plane. This makes it easier to join the sector elements together. In particular, the spring arms can easily be inserted into the corresponding indentation. The joining direction for joining the sector elements (and thus also the direction for a possible separation from each other, if needed) is perpendicular to the dividing plane, so that the spring arm and the indentation form a kind of guidance when joining, which facilitates the intended joining of the sector elements. Because a relative movement of the sector elements to each other is only possible in the direction orthogonal to the dividing plane, the sector elements are arranged especially stable to each other and accidental, unintentional detachment from each other is reliably prevented.

One embodiment of the invention is characterized in that a first one of the sector elements has a spring arm on each side of the through opening resulting in the joined state and a second one of the sector elements has a groove-shaped indentation on each side of the through opening resulting in the joined state. This arrangement and formation, symmetrical to the shaft axis, enhances the stability of the securing element in the joined state. If according to a further embodiment, the snap-fit hooks of each spring arm are arranged on the side of the respective spring arm facing away from the through opening, a particularly stable connection of the sector elements can be achieved, since a relative movement of the entire sector elements to each other has no influence on the separation of the latching connections from each other, but only the deformation of the spring arms in the indentations. This embodiment is particularly advantageous in the case of two sector elements. Alternatively, the snap-fit hooks of each spring arm are arranged on the side of the respective spring arm facing the through opening, whereby the same effect can be achieved.

The first snap-fit hooks and the second snap-fit hooks can in particular have interlocking surfaces. These are preferably inclined towards the dividing plane in such a way that they allow the sector elements to latch inseparably. Within the scope of the invention, they can be arranged in particular by an angle in a range of approx. ±10°, preferably of approx. ±5°, particularly preferably of approx. 0° to the dividing plane. Depending on how the angle is formed, the two sector elements can also be separated with greater or lesser difficulty. The angle can be used to easily define or set the force required to release the connection (related to a force acting in the plane of the sector elements). By means of a suitable angle, a separation with a relatively low force can be made possible in an advantageous way or a quasi-inseparable coupling of the two sector elements can be achieved. In addition, the configuration of the latching surfaces makes it possible to hold the latching structures together in a safe and, in particular, loss-proof manner, although it is still possible to release them with the aid of a specially designed tool, if desired.

A further embodiment of the invention is characterized by the fact that the sector elements are connected to each other by means of predetermined breaking points, which are in particular formed between the sector elements on their outer circumference. A particular advantage of this embodiment is that the securing element is provided for use in the form of an integral part. Its sector elements are connected to each other by material bridges forming the predetermined breaking points, preferably by thin areas at the outer edge/outer radius of the securing element. Before use, the sector elements can be broken apart simply by bending the securing element around its dividing plane, i.e. transversely to the disk plane. It is advantageous in this embodiment that the sector elements remain matched and connected until shortly before use. This always ensures that two sector elements that fit together 100% are joined to form a securing element and are used for securing. In addition, the groove-shaped indentation and spring arm and their latching structures, which are in engagement with each other when used as intended, are protected from undesirable influences that might restrict their function, since they are in engagement with each other and cover each other.

A tool attachment portion can be formed on at least one sector element, in particular in the form of a groove, notch, or opening made from outside for disengaging the first and second latching structures. The groove, notch, or opening is designed and positioned in such a way that the spring arm can be deformed in the groove-shaped indentation by using the attached tool and the sector elements can be separated from each other. The groove, notch, or opening has to be designed in such a way that a tool for disconnecting the connection can engage in it without protruding beyond the outer edge of the securing element. With the help of the tool, a user can then simply exert a radial force along the separation line and separate the two sector elements from each other. Preferably, the latching surfaces are arranged at a positive angle to the dividing plane. The size of this angle defines the force required to disconnect the connection.

It is particularly advantageous if the securing element is manufactured by means of jet cutting, in particular laser cutting or water jet cutting. This enables the sector elements to be manufactured with the required accuracy and without any undesirable influence on the material or distortion of the geometry.

The securing element preferably consists of two sector elements, which can in particular be designed as halves of the securing element. In addition, the securing element may consist of three or four sector elements, which may in particular be formed as a third or quarter of the securing element.

One can also say that the invention enables a securing element/an axial securing disk, which can be joined radially over/in/on a groove in a shaft and thereby locked. It can be manufactured in particular by jet cutting and is preferably made of metal. The resulting locking geometry ensures that the two disk halves/sector elements remain closed when axial forces occur. In particular, production can take place as a part whose two halves/sector elements are connected to each other by thin areas which may be designed as predetermined breaking points. Before use, the halves/sector elements are broken apart. The resulting separated, multi-part, in particular two-part disk latches by means of an inseparable snap-fit connection over/in/on a groove (inseparable without the use of a special tool intended for this purpose). The disk halves/disk parts/sector elements can, within the scope of use, in particular latch inseparably with each other and thus exhibit a high degree of robustness against axial impact loads. The axial securing disk can in particular consist of two halves which are preferably connected to each other in a form-fitting manner (or a larger number of sector elements). As a result, the two halves/sector elements cannot move apart even under massive axial loads. The inner diameter of the disk/securing element therefore does not expand as a result of an axial and/or radial load. A failure of the connection therefore only occurs when the material fails; non-destructive disconnection is not possible (without the appropriate tool). In addition, the disk is engaged over the entire circumference of the shaft groove, which results in a higher axial load capacity with unchanged installation space conditions (in particular the inner diameter).

In particular, the following advantages can be achieved by the invention:
simple handling for the user,
the initial connection of the parts of the securing element ensures that they always fit together,
no widening of the securing element on the shaft, even under extremely high loads,
full circumferential contact with the shaft, thus extremely high load capacity,
radial joining possible without the outer diameter “breathing” or being deformed,
due to the purely radial joining, no further lateral clearance in the axial direction is required for mounting, therefore particularly suitable for use in axially confined conditions,
securing element can be used several times by using special tools without wearing out due to radial widening during installation on the shaft.

### BRIEF DESCRIPTION OF THE DRAWING FIGURES

Further features and advantages of the invention result from the following exemplary and non-restrictive description of the Figures. These are only schematic in nature and only serve to understand the invention. These show:

FIG. 1a shows a top view of a securing element in an inseparable variant according to the invention before its use;

FIG. 1b shows a top view of a securing element in another inseparable variant according to the invention before its use;

FIG. 2 shows a perspective view of the securing element of FIG. 1a after separation into its individual parts (sector elements) in the scope of preparation for use;

FIG. 3 shows the separated individual parts (sector elements) of the securing element of FIGS. 1 and 2;

FIG. 4 shows a detailed representation of exemplary latching structures of the securing element of the invention; and

FIG. 5 shows schematic representations (longitudinal section and cross-section) of a securing element arranged on a shaft according to a further embodiment of the invention in a releasable variant.

### DETAILED DESCRIPTION

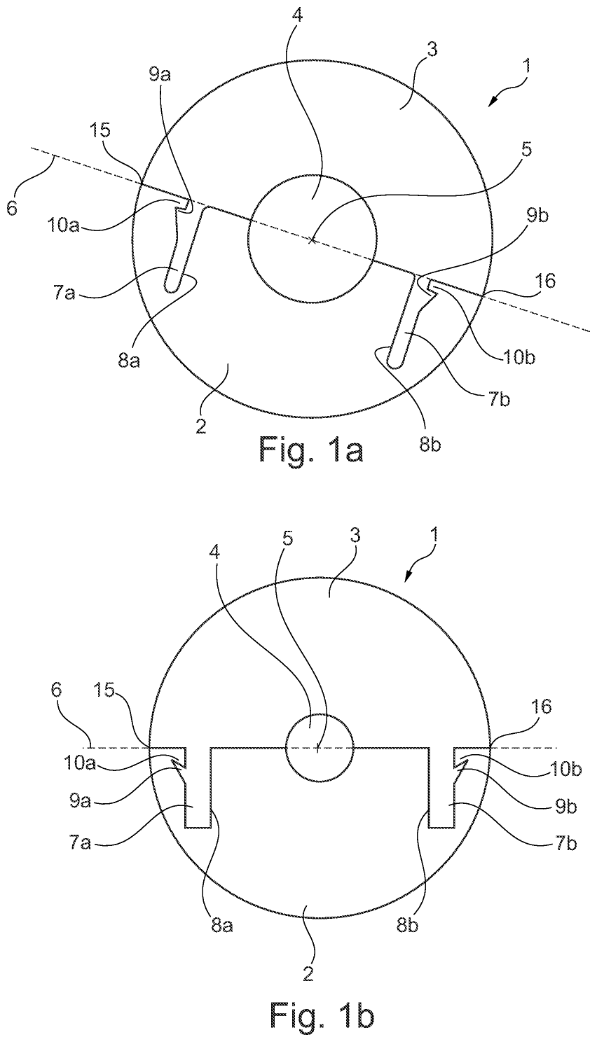

The embodiment example of a securing element 1 shown in FIG. 1a comprises a first sector element 2 and a second sector element 3. Both sector elements 2, 3 are essentially ring-segment shaped so that in the joined state (as shown in FIG. 1a) they enclose a central through opening 4. FIG. 1a shows that the securing element 1 in the joined state has a closed circular shape with the central through opening 4 in its center. The securing element 1 is divided along a dividing plane 6 passing through its center 5.

The second sector element 3 has two latching structures 7a, 7b each in the form of a spring arm 7a, 7b. The spring arm 7a is arranged on one side of the through opening 4 and the spring arm 7b is arranged on the opposite, other side of the through opening 4. Correspondingly, the first sector element 2 has two latching structures 8a, 8b each in the form of a groove-shaped indentation 8a, 8b. The groove-shaped indentation 8a is arranged on one side of the through opening 4 and the groove-shaped indentation 8b on the opposite, other side of the through opening 4. The spring arms 7a, 7b and the indentations 8a, 8b extend in a direction perpendicular to the dividing plane 6.

Each spring arm 7a, 7b is provided with a second snap-fit hook 9a, 9b on the side facing away from through opening 4. The snap-fit hooks 9a, 9b face radially outwards, i.e. they are facing away from each other and from the central through opening 4. Each of the groove-shaped indentations 8a, 8b is provided with a first snap-fit hook 10a, 10b on its side facing away from the through opening. The second snap-fit hooks 9a, 9b and the first snap-fit hooks 10a, 10b are designed to fit together so that when the two sector elements 2, 3 are joined together as intended, they hook or snap together and thus hold the sector elements 2, 3 together. As FIG. 4 in particular shows, the second snap-fit hooks 9a, 9b each have a latching surface 11 or contact surface 11, which in the present example of FIGS. 1a, 2 and 3 is aligned at an angle α of 0° to the dividing plane 6, i.e. parallel to the dividing plane 6. Correspondingly, the first snap-fit hooks 10a, 10b each have a latching surface 12 or contact surface 12, which in the present example of FIGS. 1a, 2 and 3 is also aligned at an angle of 0° to the dividing plane 6 to match the latching surfaces 11, i.e. is parallel to the dividing plane 6. FIG. 1b shows a variant in which one latching surface 11 or contact surface 11 of the second snap-fit hooks 9a, 9b is aligned at a negative angle α of about −10° to the dividing plane 6. Correspondingly, the first snap-fit hooks 10a, 10b each have a latching surface 12 or contact surface 12, which is also aligned to match the latching surfaces 11 at an angle of −10° to the dividing plane 6.

FIG. 4 also shows that the width B of the groove-shaped indentation 8a, 8b is larger than the width b of the respective spring arm 7a, 7b. The widths B and b are dimensioned in such a way that the spring arm 7a, 7b can swing in the groove-shaped indentation 8a, 8b when it is inserted into the groove-shaped indentation 8a, 8b, and can swing in the present example in the direction of through opening 4, so that its snap-fit hooks 9a, 9b can slide over the snap-fit hooks 10a, 10b of the indentation. When the intended end position is reached, in which the two sector elements 2, 3 contact each other at the dividing plane 6 (the gap shown in FIG. 4 is drawn only for better understanding of the Figure and does not exist in practice or exists only with a small gap dimension), the spring arm 7a, 7b snaps back into its original position (as shown in FIG. 4), so that the second latching structures 9a, 9b and the first latching structures 10a, 10b hook together.

As the embodiment example shows, the contact surface 11 can be formed by forming a nose-like projection 13 at the spring arm 7a, 7b. The contact surface 12 can be formed by forming a groove-like recess 14 in the indentation 8a, 8b.

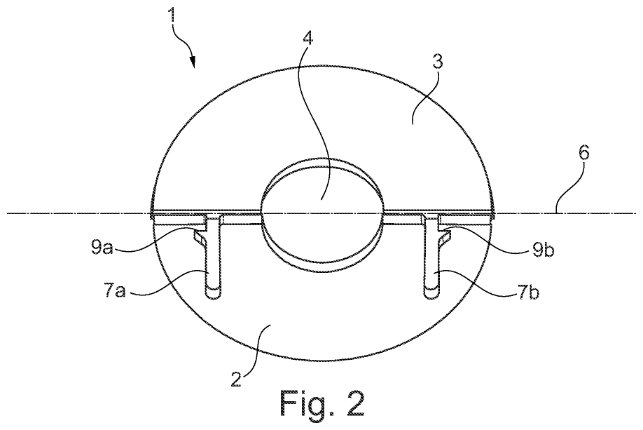

FIGS. 1a and 1b each show a top view of the securing element 1 before use. In this state, the two sector elements 2 and 3 are physically connected to each other apart from the latching structures 7a, 7b, 8a, 8b, which are in engagement with each other, i.e. via material bridges 15, 16 forming a respective predetermined breaking point 15, 16 at the opposite outer edge regions of the sector elements 2, 3. These are designed in such a way that the two sector elements 2, 3 can be bent relative to each other around a bending line lying in the dividing plane 6, which leads to a failure of the predetermined breaking points 15, 16. The two sector elements 2, 3 are then no longer physically connected to each other and can be completely separated from each other by tilting them (as shown in FIG. 2) further around the bending line lying in the dividing plane until the latching structures 7a, 7b of the second sector element 3 and the latching structures 8a, 8b of the first sector element 2 are released from their mutual engagement.

In summary, the described embodiment of the securing element 1 shows two disks having a (substantially) semicircular shape (semicircular disks), each having a semicircular outer edge and an inner, straight disk edge connecting the two ends of the semicircular outer edge and forming a semicircular notch. The semicircular notch is oriented (substantially) parallel/centered to the semicircular outer edge or they have the same circle center. In the joined state of the semicircular disks, the outer contour of the securing element 1 is (substantially) determined by the two semicircular outer edges of the semicircular disks, which limit the outward extension of the securing element 1 in the radial direction. In the joined state of the semicircular disks, the inner contour of the securing element 1 is (substantially) determined by the two semicircular notches which limit the extension of the securing element 1 in the radial direction towards the inside. The semicircular notches each divide the inner, straight disk edge of the semicircular disks into two straight edge sections, each connecting one end of the semicircular outer edge to one end of the semicircular notch.

In the embodiment of FIG. 1a, a respective latching structure is arranged (approximately) in the center of each straight edge section of the semicircular disks. In the embodiment of FIG. 1b, a respective latching structure is arranged in the respective radially outer half of each straight edge section of the semicircular disks. In an embodiment (not shown), a respective latching structure may also be arranged in the respective radially inner half of each straight edge section of the semicircular disks. The latching structures of all the above-mentioned embodiments extend (substantially) perpendicularly to the inner, straight disk edge or the straight edge sections thereof; specifically, the spring arms 7a, 7b project (substantially) perpendicularly from the inner, straight disk edge, and the grooves 8a, 8b, which each have a groove base and two side walls rising from the groove base, are formed in the semicircular disk (substantially) perpendicularly to the inner, straight disk edge. The latching devices 9a, 9b are each located on a side wall of the groove 8a, 8b.

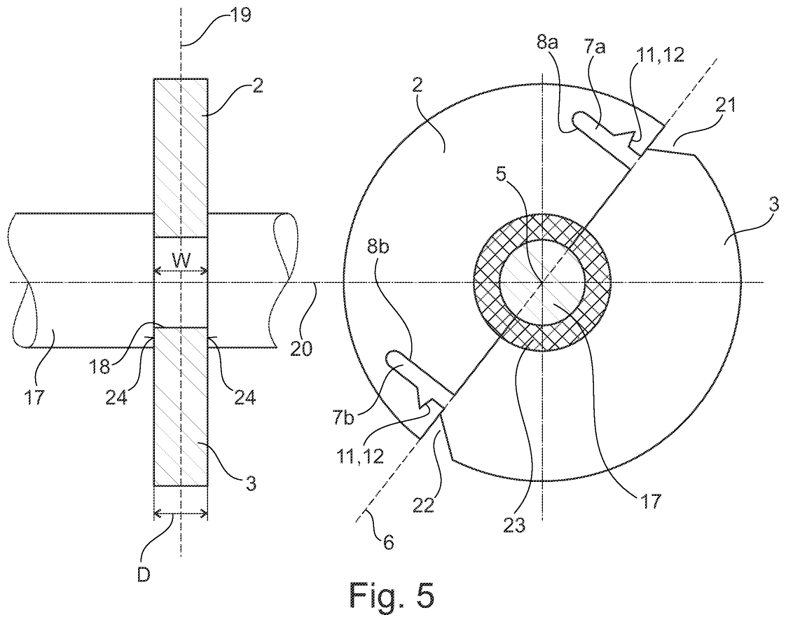

FIG. 5 shows a separable variant of the securing element 1. This essentially corresponds to the inseparable variants shown in FIGS. 1a and 1b with the exception that the latching or contact surfaces 11 and 12 are aligned here at a positive angle α of about 10° to the dividing plane.

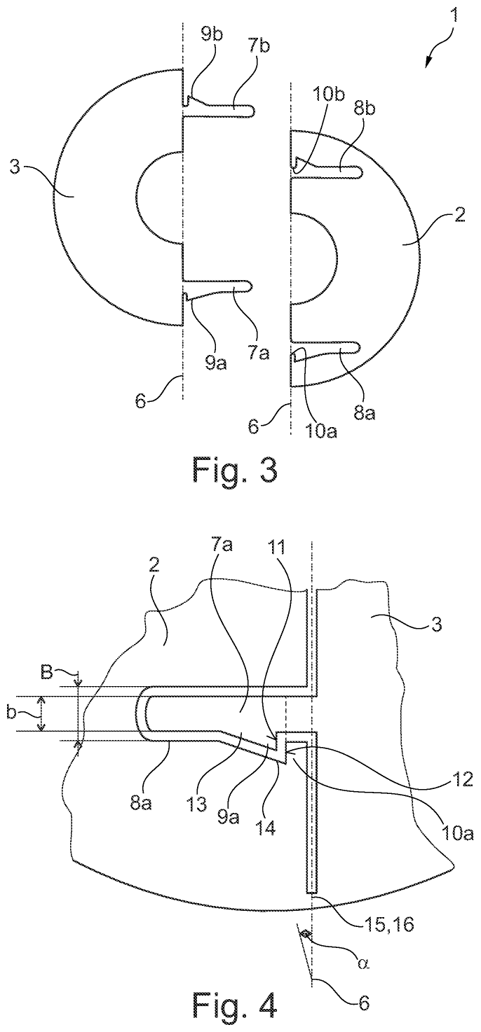

The completely separated state of both sector elements 2, 3 is shown in FIG. 3. From this state, the sector elements 2, 3 can easily be arranged on a shaft 17 in a groove 18 formed therein. For this purpose, they are placed on the opposite side of the shaft 17 in such a way that their disk plane 19 is essentially orthogonal to the longitudinal axis 20 of the shaft 17 (see sectional view of FIG. 5). Then, the two sector elements 2, 3 are placed/pushed/pressed towards each other and in the direction of the shaft 17 into the groove 18, whereby the spring arms 7a, 7b of the second sector element 3 penetrate into the groove-shaped indentations 8a, 8b of the first sector element 2 under resilient deformation, as already described above, until the contact surfaces 11, 12 latch together and form a form-fitting connection. The thickness D of the securing element 1 essentially corresponds to the width W of the groove 18, so that a position-determined position of the securing element 1 on the shaft 17 is given. FIG. 5 also shows that the two sector elements 2, 3 in their rejoined state form a fully circumferential ring shape matching the shaft 17 and the groove 18 present in it. The contact surface 23 between the groove wall 24 of the groove 18 and the securing element 1, which is marked checkered in FIG. 5, is fully circumferential and closed in the shape of a circular ring, so that an extraordinarily good load absorption and load transfer in the axial direction (in the direction of the longitudinal axis 20 of shaft 17) is ensured.

Due to the geometry of the latching structures 7a, 7b, 8a, 8b in the variants of FIGS. 1a and 1b, this form-fitting connection cannot be detached without the use of a special tool intended for this purpose, in particular not by forces and torques occurring during the use of the securing element 1, unless a plastic deformation of the material occurs. In order to allow separation of the two sector elements 2, 3 from each other and repeated use of the securing element 1, the embodiment of FIG. 5 (in addition to the positive angle a of the latching surfaces or contact surfaces 11 and 12) has a notch 21, 22 on both sides on the outside of the second sector element 3. A tool designed for this purpose can be attached here, whereby an elastic deformation of the latching structures 7a, 7b, 8a, 8b is caused, which is designed in such a way that the contact surfaces 11, 12 are detached from each other and the two sector elements 2, 3 can be detached from each other.

1. A securing element for axially securing a shaft or a component on a shaft, comprising two sector elements in the form of semicircular disks, each having a semicircular outer edge as well as an inner, straight disk edge forming a substantially semicircular notch, and which can be joined to each other to form an essentially closed ring form with a central through opening for the shaft, wherein the sector elements each have latching structures or snap-fit structures, by means of which they can be connected to each other,
wherein the latching structures comprise a groove-like indentation with a first snap-fit hook formed in a first one of the sector elements and a spring arm with a second snap-fit hook arranged on a second one of the sector elements and engaging in the indentation in the first sector element,
wherein the latching structures of each sector element are each arranged at its inner, straight disk edge, and
wherein the latching structures of each sector element are each arranged at a radial distance from its semicircular outer edge and from its semicircular notch.

2. The securing element according to claim 1, wherein the sector elements have a partial annular shape.

3. The securing element according to claim 2, wherein the sector elements are divided along a dividing plane in which the longitudinal axis of a shaft lies when arranged as intended on the shaft.

4. The securing element according to claim 3, wherein the groove-like indentation and the spring arm extend orthogonally to the dividing plane.

5. The securing element according to claim 1, wherein the second one of the sector elements has a respective spring arm on one side of the through opening resulting in the joined state and the first one of the sector elements has a respective groove-like indentation on one side of the through opening resulting in the joined state.

6. The securing element according to claim 1, wherein the snap-fit hooks of each spring arm are arranged on the side of the respective spring arm facing away from the through opening, or wherein the snap-fit hooks of each spring arm are arranged on the side of the respective spring arm facing the through opening.

7. The securing element according to claim 1, wherein the second snap-fit hooks and the first snap-fit hooks have interlocking surfaces which are inclined with respect to the dividing plane in such a way that they enable the sector elements to be latched in an undetachable manner.

8. The securing element according to claim 1, wherein the sector elements are connected to each other by predetermined breaking points.

9. The securing element according to claim 1, wherein a tool attachment portion is formed on at least one sector element in order to disengage the first and second latching structures.

10. The securing element according to claim 1, wherein the semicircular notch of each sector element divides its inner, straight disk edge into two straight edge sections, and a respective latching structure is arranged centrally on each straight edge section of the sector elements.

11. The securing element according to claim 1, wherein the semicircular notch of each sector element divides its inner, straight disk edge into two straight edge sections, and a respective latching structure is arranged in a respective radially outer half of the straight edge sections.

12. A method for producing the securing element according to claim 1, wherein the securing element is produced by laser cutting or water jet cutting.
